(19) United States
(12) Patent Application Publication
(10) Pub. No.: US 2007/0026299 A1
(43) Pub. Date: Feb. 1, 2007

(54) Apparatus for locking detachable battery pack case of portable terminal

(75) Inventors: Jeong-Seok Park, Suwon-si (KR); Kwang-Ho Jung, Suwon-si (KR); June-Sop Kim, Seoul (KR)

Correspondence Address: DILWORTH & BARRESE, LLP, 333 EARLE OVINGTON BLVD., UNIONDALE, NY, 11553, US

(73) Assignee: Samsung Electronics Co., Ltd., Suwon-si (KR)

(21) Appl. No.: 11/493,507

(22) Filed: Jul. 26, 2006

(30) Foreign Application Priority Data
Jul. 28, 2005 (KR) 2005-69024

(51) Int. Cl. H01M 2/10

(52) U.S. Cl. 429/97; 429/99

(57) ABSTRACT

Disclosed is a detachable battery pack case locking apparatus of a portable terminal. The case is mounted to the lower case frame of a body, and the apparatus includes locker housings provided on both side surfaces of the lower case frame, locker assemblies engaged with the locker housings, for restricting or releasing the case of the battery pack by pressing the locker assemblies in both directions to slide the locker assemblies and thus attach or detach locking members formed in the case of the battery pack, and resilient members providing resilient forces so that the locker assemblies are slid.

### PRIORITY

This application claims priority to an application entitled “Apparatus For Locking Detachable Battery Pack Case Of Portable Terminal” filed with the Korean Intellectual Property Office on Jul. 28, 2005 and assigned Serial No. 2005-69024, the contents of which are incorporated herein by reference.

### BACKGROUND OF THE INVENTION

1. Field of the Invention

The present invention relates to an apparatus for locking a detachable battery pack case of a portable terminal, and more particularly to a detachable battery pack case locking apparatus of a portable terminal, by which a case of a detachable battery pack can be attached to or detached from the portable terminal by pushing both side surfaces of the terminal body.

2. Description of the Related Art

Generally, a detachable battery pack 10 of a portable terminal is used as a power supply source and is mounted and electrically connected to the body 1 of the terminal, as shown in the conventional detachable battery pack case locking apparatus in FIG. 1. The case 40 of the battery pack is restrained and released by a locker assembly 20 installed in the body 1.

The case 40 of the detachable battery pack 10 can be mounted to the body 1 of the terminal by either slidably mounting the case 40 to the rear surface of the body 1 by using a guide rib, or catching one end of the case by using a catching portion and then moving the case to the lower side of the catching portion.

As shown in FIG. 1, a battery pack 10 is electrically connected to the rear surface of the body 1 including a lower case frame 1a.

A mounting surface 1b is formed on the rear surface of the lower case frame 1a. A connecting terminal (not shown) protrudes from one end of the mounting surface 1b, and a locker seat 1c is formed at the other end of the mounting surface 1b at a position of the rear surface of the lower case frame 1a. A locker assembly 20 for fixing the case 40 of the battery pack 10 is provided at the locker seat 1c.

In order to mount the battery pack 10 to the body 1, the battery pack 10 is placed on the mounting surface 1b formed on the rear surface of the body 1. Then, as shown in FIG. 2, a locker protuberance 21 is inserted into and engaged with a locker protuberance room 41 formed in the case 40. Then, the case 40 is firmly fixed to the body by the locker protuberance 21.

FIG. 2 is a cross-sectional view of a conventional case locking apparatus of a detachable battery pack. In order to separate the case 40 of the detachable battery pack 10 from the body 1, if the locker protuberance 21 is pulled horizontally to be slid, the locker protuberance 21 is deviated from the locker protuberance room 41 of the case 40 and thus separated from the body 1.

In order to guarantee the horizontal sliding of the locker protuberance 21, a movement space through which to horizontally slide the locker protuberance 21 is formed in the locker seat 1c.

As shown in FIG. 2, at least one guide rib 23 is mounted to the lower case frame 1a of the terminal body 1 to be guided vertically.

A hook head 23a is formed at one end of the guide rib 23. The hook head 23a is latched by a latching stopper 2 formed in the lower case frame 1a to prevent the locker protuberance 21 from deviating to the outside when the locker protuberance 21 is slid horizontally once it is mounted. Further, a spring is used as a resilient means to provide the locker protuberance 21 with a resilient force. One end of the spring 30 is supported by the lower case frame 1a. The spring 30 is installed in a manner in which it resiliently presses the locker protuberance 21.

However, according to the conventional detachable battery pack case locking apparatus of the portable terminal, since the movement space should be formed in the locker seat of the lower case frame through which to horizontally slide the locker protuberance 21, the size of the terminal is large and the appearance of the terminal is unappealing due to the movement space of the terminal.

Further, since a fingernail of a user is inserted into the locker to horizontally pull and slide the locker, the fingernail of the user is occasionally bent or broken.

Furthermore, the movement space for pulling the locker in the conventional detachable battery pack case locking apparatus of the portable terminal is limited, the structure of the locking apparatus is complex and the productivity and reliability of the terminal is difficult to attain.

### SUMMARY OF THE INVENTION

Accordingly, the present invention has been made to solve the above-mentioned problems occurring in the prior art, and an object of the present invention is to provide a detachable battery pack case locking apparatus of a portable terminal in which the battery pack case can be easily separated and engaged by pushing both side surfaces of the body of the terminal.

It is another object of the present invention to provide a detachable battery pack case locking apparatus of a portable terminal in which the battery pack case is detached and attached by pushing both side surfaces of a body of the terminal, so as to provide a terminal that has a simple structure and an appealing design, and can be miniaturized by reducing the installation space.

In order to accomplish the objects, there is provided an apparatus for locking a detachable battery pack case of a portable terminal, the case being mounted to a lower case frame of a body, the apparatus including locker housings provided on both side surfaces of the lower case frame; locker assemblies engaged with the locker housings, for restricting or releasing the case of the battery pack by pressing the locker assemblies in both directions to slide the locker assemblies and thus attaching and detaching locking members formed in the case of the battery pack; and resilient members providing resilient forces so that the locker assemblies are slidably moved.

### BRIEF DESCRIPTION OF THE DRAWINGS

The above and other objects, features, and advantages of the present invention will be more apparent from the following detailed description taken in conjunction with the accompanying drawings, in which:

FIG. 1 is a perspective view of a conventional detachable battery pack case locking apparatus of a portable terminal;

FIG. 2 is a cut-away plan view of a conventional detachable battery pack case locking apparatus of a portable terminal;

FIG. 3 is an exploded perspective view of a detachable battery pack case locking apparatus of a portable terminal according to a preferred embodiment of the present invention;

FIG. 4 is a perspective view of the engaged state of a detachable battery pack case locking apparatus of a portable terminal according to a preferred embodiment of the present invention;

FIG. 5 is a perspective view of locking members of a case in a detachable battery pack case locking apparatus of a portable terminal according to a preferred embodiment of the present invention;

FIG. 6 is a plan view of the engaged state of a detachable battery pack case locking apparatus of a portable terminal according to a preferred embodiment of the present invention;

FIG. 7 is an exploded perspective view of the portion A of FIG. 6;

FIG. 8 is a perspective view of the state before the operation of a detachable battery pack case locking apparatus of a portable terminal according to a preferred embodiment of the present invention;

FIG. 9 is a plan view of the state before the operation of a detachable battery pack case locking apparatus of a portable terminal according to a preferred embodiment of the present invention;

FIG. 10 is a perspective view of an operational process of a detachable battery pack case locking apparatus of a portable terminal according to a preferred embodiment of the present invention;

FIG. 11 is a plan view of an operational process of a detachable battery pack case locking apparatus of a portable terminal according to a preferred embodiment of the present invention;

FIG. 12 is a perspective view of the state after the operation of a detachable battery pack case locking apparatus of a portable terminal according to a preferred embodiment of the present invention;

FIG. 13 is a plan view of the state after the operation of a detachable battery pack case locking apparatus of a portable terminal according to a preferred embodiment of the present invention;

FIG. 14 is a plan view of the state in which a case of a detachable battery pack case locking apparatus of a portable terminal according to a preferred embodiment of the present invention is separated; and

FIG. 15 is an enlarged cross-sectional view for showing the portion B of FIG. 14.

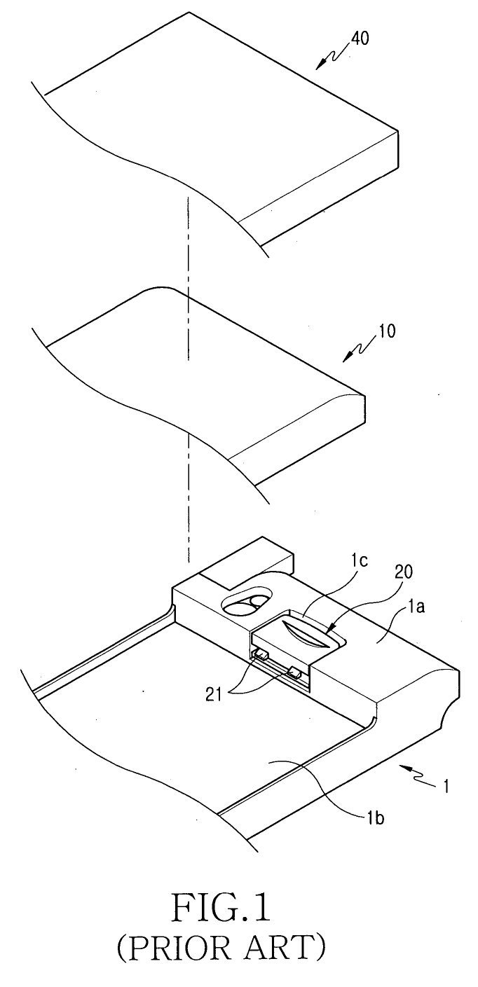

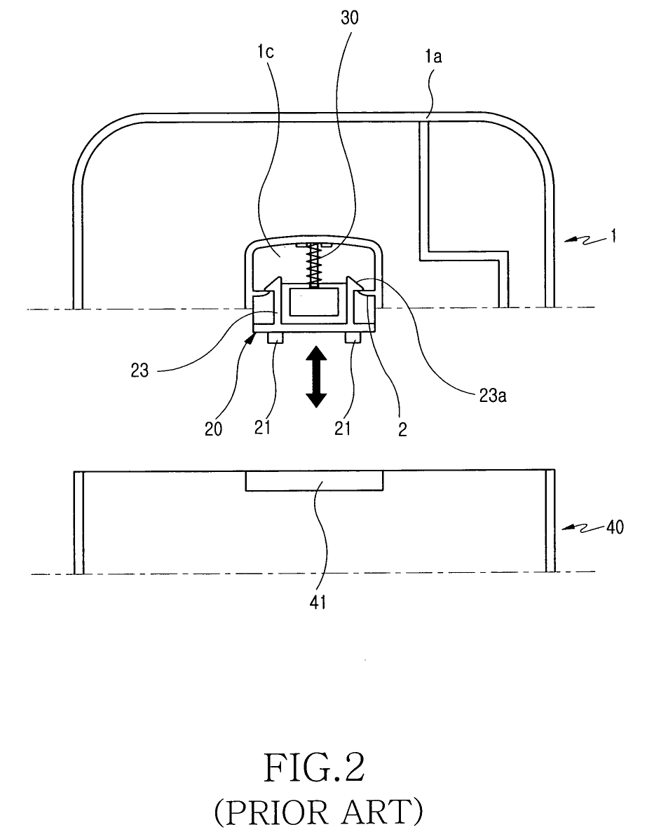

### DETAILED DESCRIPTION OF THE PREFERRED EMBODIMENT

Hereinafter, preferred embodiments of the present invention will be described with reference to the accompanying drawings. It is noted that the same reference numerals are used with respect to the elements which have the same functions as the conventional elements.

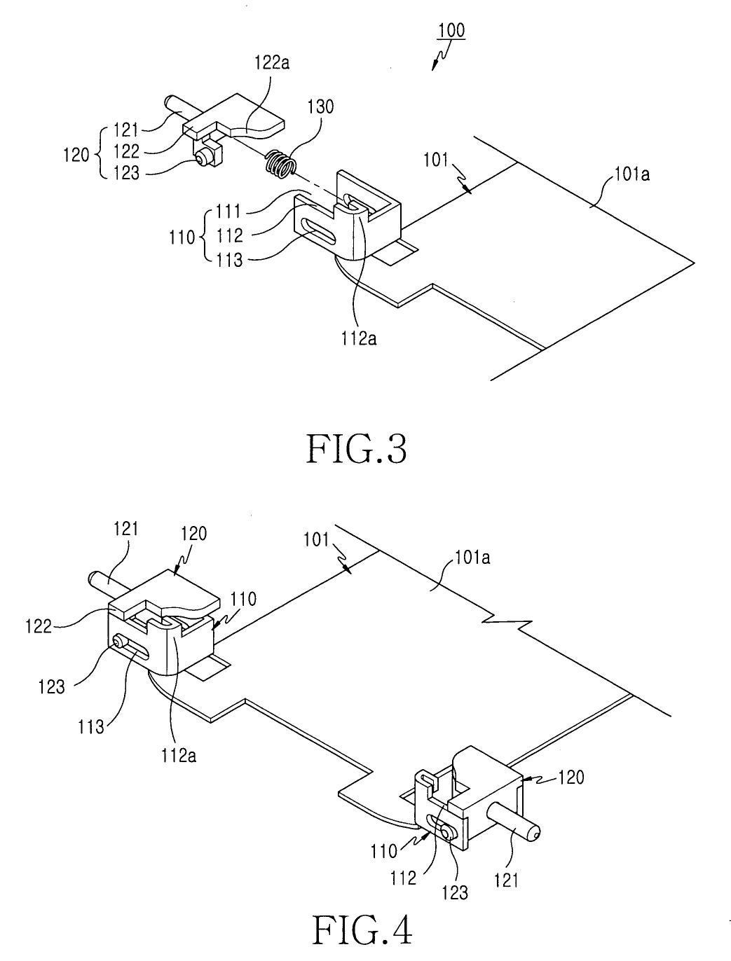

As shown in FIGS. 3 to 5, a detachable battery pack case locking apparatus 100 of a portable terminal according to a preferred embodiment of the present invention includes a pair of locker housings 110, a pair of locker assemblies 120 and resilient members 130. The locker housings 110 are provided on both side surfaces of a lower case frame 1a of a body 1 so that the locker assemblies 120 are slidably engaged therewith. The locker assemblies 120 are engaged with the locker housings 110 so that a case 40 of a detachable battery pack 10 can be restricted or released by pressing button portions 121 of the locker assemblies 120 to slide the locker assemblies 120, thereby attaching and detaching locking members 140 formed in the case 40 of the battery pack 10. The resilient members 130 are provided in the locker housings 110 to provide resilient forces so that the locker assemblies 120 are slidably moved.

Further, a mounting member 101 in which a mounting surface 101a is formed so that the battery pack 10 is mounted thereto is provided on the lower case frame 1a.

The locker housings 110 are provided on both surfaces of the mounting member 101. A receiving space 111 for receiving the locker assembly 120 and the spring 130 is formed in each of the locker housings 110. A guide surface 112 is formed on the upper end surface of the receiving space 111 to guide the slide of the locker assembly 120. A deviation preventing portion 113 is provided on the lower side of the guide surface 112 to prevent the locker assembly 120 from being separated from the locker housing 110 when the locker assembly 120 is slid.

A locker stopping portion 112a is formed at a predetermined position of the guide surface 112 to stop the slide movement of the locker assembly 120 and to be engaged with or separated from the locking member 140 of the case 40 of the battery pack 10.

As shown in FIGS. 4 and 15, the deviation preventing portion 113 includes a stopper hole to be engaged with a movable boss 123 formed in the locker assembly 120, thereby restricting the slide movement of the locker assembly 120.

The locker housings 110 are preferably substantially U-shaped.

As shown in FIGS. 4, 6, 7, 12 and 13, each of the locker assemblies 120 includes a locker button 121, a slide locker 122 and a movable boss 123. The locker button 121 protrudes to the outside from the side surface of the body 1. The slide locker 122 is slidably engaged with the locker housing 110. The slider locker 122 is formed on the rear side of the locker button 121 so that it slides together with the locker button 121 and pushes the locking member 140 of the case 40 to be engaged with or deviated from the locker stopping portion 112a of the locker housing 110. The movable boss 123 is formed on the lower side of the slide locker 122 so that it is slid in the stopper hole of the deviation preventing portion 113 to restrain the slide movement of the slide locker 122.

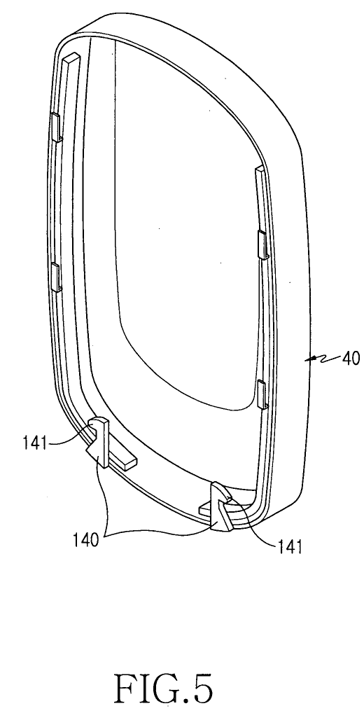

As shown in FIGS. 5, 8 and 9, the slide locker 122 has a contact surface 122a which can make contact with the locking member 140 of the case 40 of the battery pack 10. The contact surface 122a is curved so as to easily make contact with the locking member 140 of the case 40.

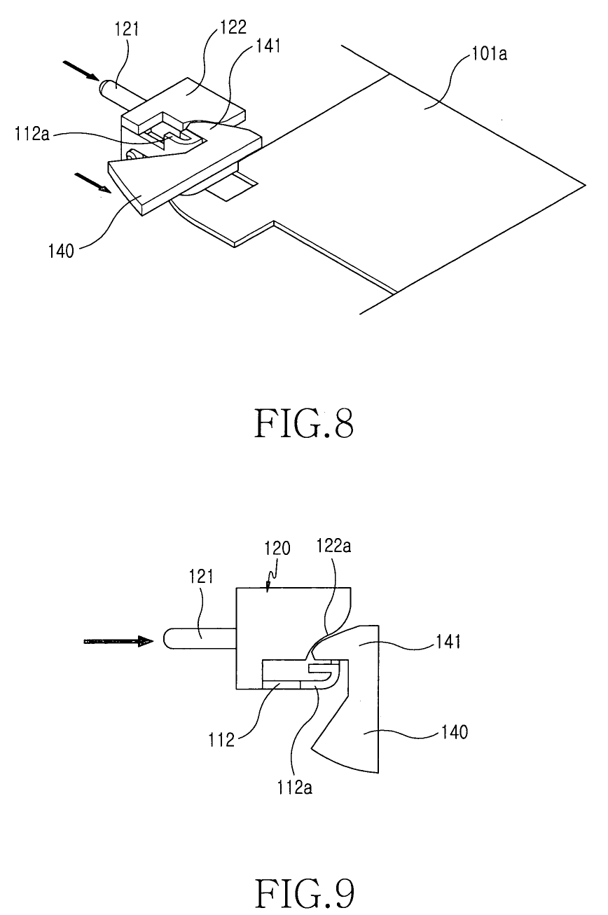

As shown in FIGS. 8 to 11, the locking member 140 has a catching jaw 141 which can be engaged with or deviated from the locker stopping portion 112a.

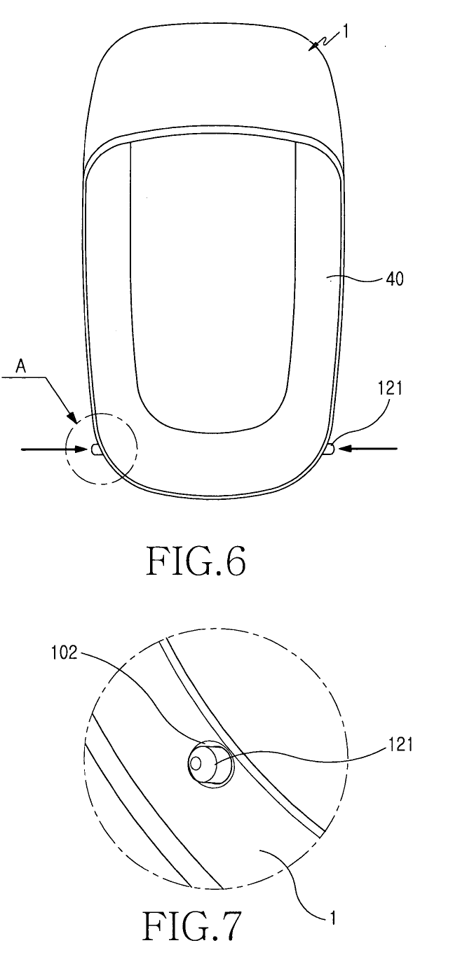

As shown in FIGS. 6 and 7, a pair of button holes 102 is formed on both side surfaces of the lower case frame 1a so that the locker buttons 121 protrude outside the body 1.

As shown in FIG. 15, the resilient member 130 is preferably a coil spring.

As shown in FIGS. 3 and 4, the battery pack case locking apparatus 100 includes the locker housings 110, the locker assemblies 120 and the resilient members 130. The mounting member 101 for mounting the battery pack 10 is provided in the lower case frame 1a, and the pair of locker housings 110 are provided on both side surfaces of the mounting member 101.

In this state, the resilient member 130 for providing a resilient force enabling the slide movement of the locker assembly 120 is inserted into the receiving space 111 formed in the locker housing 110, and the locker assembly 120 is engaged. Since the deviation preventing portion 113 for preventing the deviation of the locker assembly 120 is provided in the locker housing 110, the movable boss 123 of the locker assembly 120 is inserted into and engaged with the stopper hole of the deviation preventing portion 113.

In this state, as shown in FIG. 6, the battery pack 10 is mounted to the mounting surface 101a of the lower case frame 1a, and the case 40 of the battery pack 10 is engaged with the upper surface of the battery pack 10.

Then, as shown in FIGS. 5, 12 and 13, the locking member 140 of the case 40 is caught and restrained by the locker stopping portion 112a of the locker housing 110, making contact with the contact surface 122a formed in the slide locker 122 of the locker assembly 120. The catching jaw 141 formed in the locking member 140 is caught by the locker stopping portion 122a.

As shown in FIGS. 6 and 7, the locker button 121 of the locker assembly 120 protrudes to the outside through the button hole 102 formed in the body 1. The locker buttons 121 protrude from both side surfaces of the body 1, and the case 40 of the battery pack 10 is mounted to the lower case frame 1a of the body 1.

As shown in FIGS. 8 and 9, in order to separate the case 40 of the battery pack 10 from the lower case frame 1a of the body 1, the locker buttons 121 protruding from both side surfaces of the body 1 are pressed simultaneously to the inner side of the body 1.

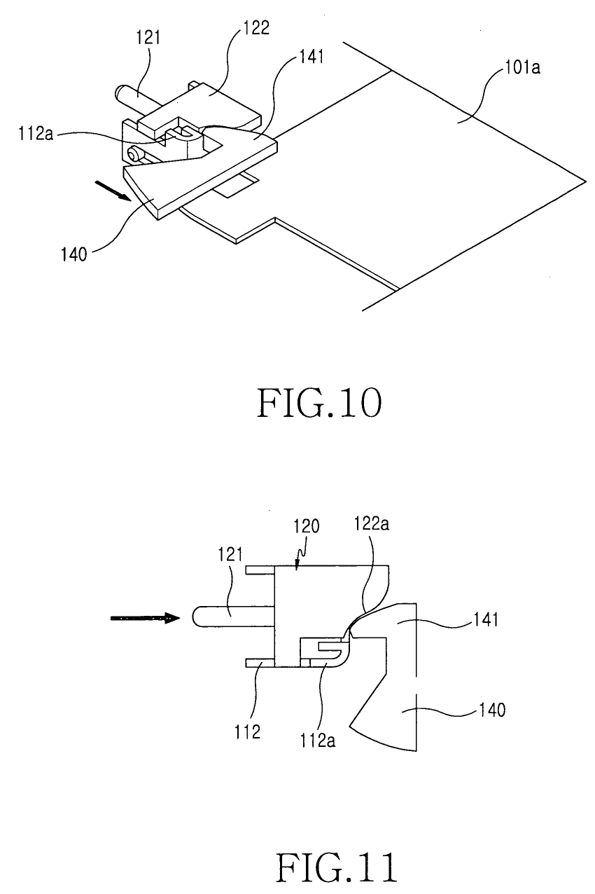

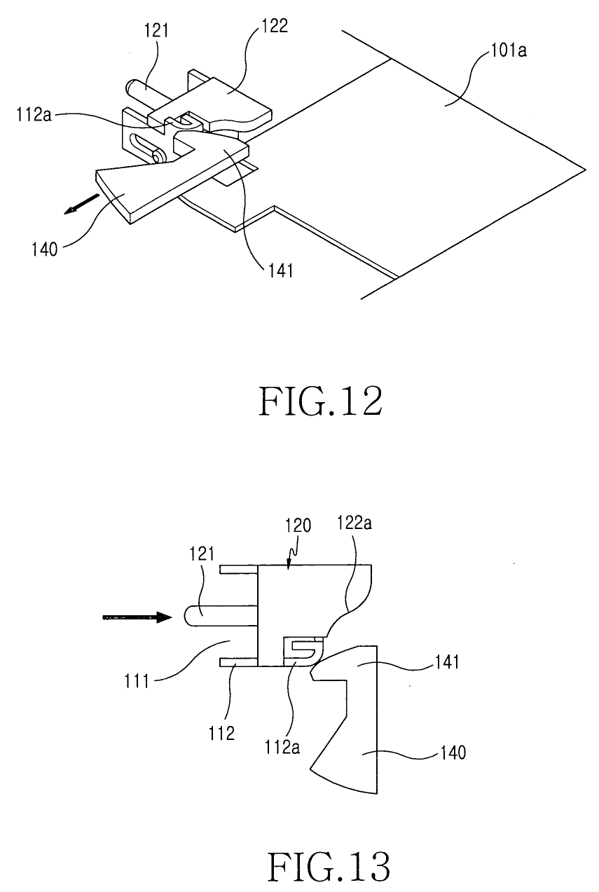

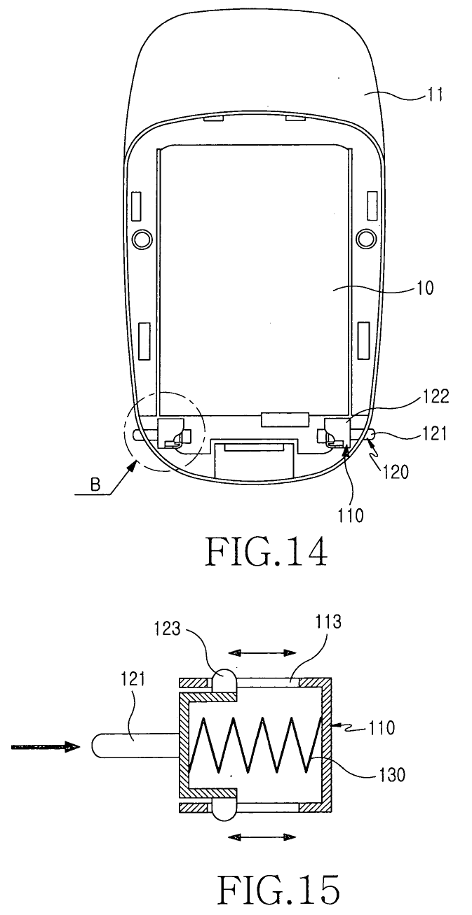

As shown in FIGS. 10 and 11, if the locker buttons 121 are pressed and moved to the inner side of the body 1, the slide lockers 122 are slid. As shown in FIGS. 12 and 13, the locking members 140 of the case 40 which make contact with the contact surfaces 122a of the slide lockers 122 are slid to the inner side together with the slide locker 122, and at the same time, the catching jaws 141 of the locking members 140 deviate from the locker stopping portions 112a formed in the locker housings 110, releasing the catching state. Then, as shown in FIG. 11, the slide lockers 122 are guided along the guide surfaces 112 formed in the locker housings 110.

As shown in FIGS. 4 and 12, the slide lockers 122 make contact with the locker stopping portions 112a and slide movement thereof is stopped, and the movable bosses 123 formed on the lower side of the sliding lockers 122 are restricted from sliding in the stopper hole of the deviation preventing portions 113.

In this state, the case 40 of the battery pack 10 is separated from the body 1.

As shown in FIGS. 10 and 11, if the locker buttons 121 are released, the locker assemblies 120 are slid to the initial positions along the guide surfaces 112 by the resilient members 130 provided in the locker housings 110. Then, the locker buttons 121 protrude again from the button holes 102 of the body 1.

As mentioned above, with a case locking apparatus which attaches and detaches a detachable battery pack case by pressing button portions protruding from both side surface of a lower case frame of a terminal, the detachable battery pack case can be separated and engaged easily.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. An apparatus for locking a detachable battery pack case of a portable terminal, the case being mounted to a lower case frame of a body, the apparatus comprising:
locker housings provided on both side surfaces of the lower case frame;
locker assemblies engaged with the locker housings for restricting or releasing the case of a battery pack by pressing the locker assemblies in both directions to slide the locker assemblies and thus attach or detach locking members formed in the case of the battery pack; and
resilient members for providing resilient forces so that the locker assemblies are slidably moved.

2. An apparatus according to claim 1, wherein a mounting member having a mounting surface for mounting a detachable battery pack thereto is provided on the lower case frame and the locker housing is provided on both side surfaces of the mounting member.

3. An apparatus according to claim 1, wherein the locker housings have receiving spaces for receiving the locker assemblies and the resilient members, guide surfaces for guiding slide movement of the locker assemblies and deviation preventing portions for preventing deviation of the locker assemblies from the locker housings when the locker assemblies are slid.

4. An apparatus according to claim 3, wherein locker stopping portions are formed at predetermined positions of the guide surfaces to stop the slide movements of the locker assemblies and to engage or separate from the locking members of the case.

5. An apparatus according to claim 3, wherein the deviation preventing portions include stopper holes to be engaged with a pair of movable bosses formed in the locker assemblies, thereby restricting the slide movement of the locker assemblies.

6. An apparatus according to claim 1, wherein the locker housings are substantially U-shaped.

7. An apparatus according to claim 3, wherein each of the locker assemblies comprises:
a locker button protruding outside a side surface of the body;
a slide locker formed on a rear side of the locker button and slidably engaged with the locker housing, the slide locker being slid by pressing the locker button and pushing the locking member of the case to engage with or deviate from a locker stopping portion of the locker housing; and
a movable boss formed on a lower side of the slide locker so that it slides in the stopper hole of the deviation preventing portion to restrain slide movement of the slide locker.

8. An apparatus according to claim 7, wherein the slide locker has a curved contact surface that makes contact with the locking member of the case.

9. An apparatus according to claim 4, wherein each of the locking members of the case has a catching jaw so as to be engaged with or deviated from the locker stopping portion.

10. An apparatus according to claim 7, wherein a button hole for receiving the locker button protruding outside is formed on each side surface of the lower case frame.

11. An apparatus according to claim 1, wherein the resilient members are coil springs.

12. An apparatus for locking a detachable battery pack case of a portable terminal, the case being mounted to a lower case frame of a body, the apparatus comprising locking device portions for restricting or releasing the case of the battery pack, which locking device portions are slid when pressed in an inward direction to the body, thereby attaching or detaching the case of the battery pack.
